(19) United States
(12) Patent Application Publication
(10) Pub. No.: US 2012/0051765 A1
(43) Pub. Date: Mar. 1, 2012

(54) IMAGE FORMING APPARATUS AND METHOD OF CONTROLLING THE SAME

(75) Inventors: Takahiro Kuroda, Toyokawa-shi (JP); Hidetoshi Noguchi, Tahara-shi (JP); Kazuyoshi Hara, Itami-shi (JP); Satoru Shibuya, Chiryu-shi (JP)

(73) Assignee: Konica Minolta Business Technologies, Inc., Tokyo (JP)

(21) Appl. No.: 13/221,423

(22) Filed: Aug. 30, 2011

(30) Foreign Application Priority Data
Aug. 31, 2010 (JP) 2010-193495

(51) Int. Cl. G03G 15/16; G03G 15/00

(52) U.S. Cl. 399/44; 399/66; 399/313

(57) ABSTRACT

An image forming apparatus includes a contact transfer device, a bias applying device, a transfer current sensor, a leakage current adjustor, and a controller. The contact transfer device is configured to transfer a toner image onto a surface of a sheet conveyed in a predetermined direction. The bias applying device is configured to apply a bias to the contact transfer device. The transfer current sensor is configured to sense a value of a transfer current flowing through the sheet at an image transfer position. The leakage current adjustor is configured to adjust an amount of a leakage current flowing from the contact transfer device along the surface of the sheet. The controller is configured to control the leakage current adjustor to maintain an amount of the transfer current within a reference range based on the value of the transfer current sensed by the transfer current sensor.

### CROSS-REFERENCE TO RELATED APPLICATIONS

The present application claims priority under 35 U.S.C. §119 to Japanese Patent Application No. 2010-193495, filed Aug. 31, 2010. The contents of this application are herein incorporated by reference in their entirety.

### BACKGROUND OF THE INVENTION

1. Field of the Invention

The present invention relates to an image forming apparatus and a method for controlling the image forming apparatus.

2. Discussion of the Background

Some of electrophotographic image forming apparatuses use toner. A sheet (also referred to as a sheet of transfer material or a sheet of recording medium) is conveyed in a predetermined direction and brought into contact with a toner carrier such as a transfer belt and a photosensitive drum. The sheet is then pressed against the toner carrier with a bias applied to the toner carrier to transfer (second-transfer) a toner image onto the sheet.

There are preferable ranges for current involved in the transfer. In view of this, the output value of the bias is set to ensure that the value of a transfer current passing through a sheet is maintained within a preferable range. In operation, the amount of the current consumed in the transfer differs from the output value of the bias due to current leakage through the sheet and guide members. The problem with this is that the amount of the leakage current varies due to various factors such as environment.

The difference between the actual transfer current value and the output value particularly increases when the sheet is of paper; the humidity of the entire paper may change due to weather, or the humidity of one sheet of paper may vary portion by portion. Specifically, a high paper humidity lowers resistance and increases the current flowing through the paper. This reduces the current to be consumed in the transfer below a necessary range, resulting in increased occurrence of failed transfer. However, an excessively high paper resistance causes failures such as discharge noise, also resulting in increased occurrence of failed transfer.

The resistance of sheets also varies depending on their material, thickness, and size. This can be addressed, in some cases, by selecting the type of the sheet of paper on the print menu to set a corresponding bias. However, in the cases of unexpected materials or thicknesses, the resulting bias may not be accurate, which may cause failed transfer.

In view of this, it is common practice to control the transfer current within predetermined ranges even though the transfer environment changes. For example, Japanese Unexamined Patent Application Publication No. 08-087185 discloses a moisture adsorbing degree detecting part that senses the humidity of a sheet of paper sent to a transfer unit, wherein the output of bias is controlled based on the humidity of the sheet of paper.

Japanese Unexamined Patent Application Publication No. 11-219042 discloses control including sensing the value of a leakage current flowing from a transfer unit through a sheet of paper to a pre-transfer guide, and reducing the bias output voltage when the leakage current exceeds a predetermined threshold value.

Japanese Unexamined Patent Application Publication No. 2007-86814 discloses current sensing means that senses the value of transfer current flowing through a sheet of paper, wherein the output of current is adjusted based on the amount of the sensed current to control current flowing through a transfer unit within a predetermined range.

The contents of Japanese Unexamined Patent Application Publication No. 08-087185, Japanese Unexamined Patent Application Publication No. 11-219042, and Japanese Unexamined Patent Application Publication No. 2007-86814 are herein incorporated by reference in their entirety.

Incidentally, ensuring satisfactory transfer in spite of changes in transfer environment requires a) the transfer unit be supplied an amount of current that is maintained within a range without excess or deficiency (reliability to maintain necessary current). This in turn requires b) the amount of current consumed in transfer be accurately sensed (accuracy of sensing).

Further, considering that the humidity of a sheet such as of paper may vary portion by portion, it is required c) the sensing of the amount of current and the control be carried out in a real-time manner (real-time control). It is also required d) the voltage application during the transfer remain unchanged as far as possible (bias stability). This in turn requires e) the current leaking to the guides or other members through the sheet be controlled (control of leakage current).

The cited patent documents will be studied in terms of these requirements. Regarding Japanese Unexamined Patent Application Publication No. 08-087185, the accuracy of sensing is poor in that the current consumed at the transfer unit is calculated indirectly, i.e., based on the resistance of a sheet of paper. The real-time performance is also poor in that a moisture absorption degree of a sheet of paper is sensed only once and the control is carried out only once. This also results in poor reliability to maintain a necessary current. Further, controlling the application voltage results in poor bias stability.

Japanese Unexamined Patent Application Publication No. 11-219042 lacks accuracy of sensing and real-time performance in that the current consumed at the transfer unit is sensed indirectly, i.e., based on leakage current passing through a sheet of paper, and that the sensing is carried out only once with respect to one sheet of paper. This also results in poor reliability to maintain a necessary current. Further, changing the bias output results in a lack of bias stability.

Japanese Unexamined Patent Application Publication No. 2007-86814 provides satisfactory accuracy of sensing and real-time performance in that the value of the current passing through a sheet of paper is directly sensed. This ensures that the current at the transfer unit is maintained within a necessary range. However, changing the bias output results in poor bias stability, similarly to the other cited patent documents. Further, the document gives no consideration to the control of leakage current.

Additionally in Japanese Unexamined Patent Application Publication No. 2007-86814, when a sheet of paper has a high resistance and the transfer unit is made of a high resistance member, increasing the output voltage may cause adverse effects including discharge and a change in toner polarity. When a sheet of paper has a low resistance and the transfer unit is made of a low resistance member, the current at the transfer unit may not be reduced to within a predetermined range even by lowering the output voltage.

### SUMMARY OF THE INVENTION

According to one aspect of the present invention, an image forming apparatus includes a contact transfer device, a bias applying device, a transfer current sensor, a leakage current adjustor, and a controller. The contact transfer device is configured to transfer a toner image onto a surface of a sheet conveyed in a predetermined direction. The bias applying device is configured to apply a bias to the contact transfer device. The transfer current sensor is configured to sense a value of a transfer current flowing through the sheet at an image transfer position. The leakage current adjustor is configured to adjust an amount of a leakage current flowing from the contact transfer device along the surface of the sheet. The controller is configured to control the leakage current adjustor to maintain an amount of the transfer current within a reference range based on the value of the transfer current sensed by the transfer current sensor.

According to another aspect of the present invention, a method is for controlling an image forming apparatus. The image forming apparatus includes a contact transfer device configured to, when biased, transfer a toner image onto a surface of a sheet conveyed in a predetermined direction. The method includes sensing a value of a transfer current flowing through the sheet at an image transfer position. An amount of a leakage current flowing from the contact transfer device along the surface of the sheet is adjusted based on the value of the transfer current sensed in the sensing step so as to maintain an amount of the transfer current within a reference range.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic cross-sectional view of a printer that is an image forming apparatus according to an embodiment of the present invention;

FIG. 2 is an enlarged view of main components of the printer;

FIGS. 3A, 3B, and 3C are diagrams illustrating control according to an embodiment of the present invention; and

FIG. 4 is a flowchart of a control procedure.

### DESCRIPTION OF THE EMBODIMENTS

The embodiments will now be described with reference to the accompanying drawings, wherein like reference numerals designate corresponding or identical elements throughout the various drawings.

As used herein, the term “image forming apparatus” encompasses various machines, apparatuses, and appliances with printing functions. Examples include, but not limited to, monofunctional machines with printing functions such as copiers, printers, and facsimiles, and multifunctional machines with printing, scanning, communication, and other functions.

In the embodiment of the present invention, a transfer current sensor senses the value of the transfer current. As used herein, “the value of the transfer current” encompasses various values including the absolute value of the transfer current. Other examples include, but not limited to, a value indicating whether the transfer current is lower or higher than a reference value, and a value of deviation or a deviation rate from the reference value. When the value to sense is of deviation or a deviation rate from the reference value, a median value may be used as a single reference value, or an upper-limit value and a lower-limit value may be used as two reference values.

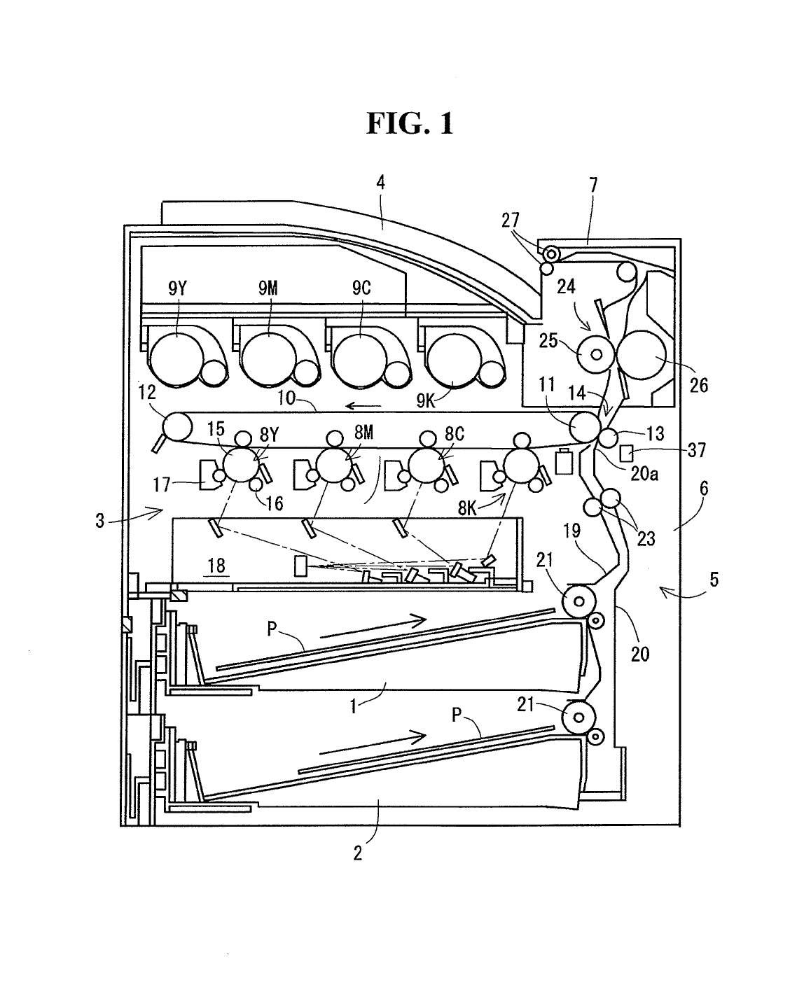

The embodiment of the present invention is applied to a printer. First, an overview of the printer will be described by referring to FIG. 1. In this embodiment, the term “sheet” refers to paper (hereinafter referred to as a “sheet of paper”).

### (1) Overview of a Printer

As shown in FIG. 1, a printer includes two-stage feeding cassettes 1 and 2, an image processing unit 3 disposed above the feeding cassettes 1 and 2, a collection tray 4 disposed above the image processing unit 3, and a conveyer path (feeding unit) 5 through which sheets of paper P are conveyed from the feeding cassettes 1 and 2 toward the collection tray 4. The collection tray 4 is exposed on the top surface of a housing 6 that defines the exterior of the printer. An operation unit 7 is also disposed on the top surface of the housing 6.

The printer of this embodiment is full color-enabled. Specifically, the image processing unit 3 includes four image forming units 8Y, 8M, 8C, and 8K respectively corresponding to yellow Y, magenta M, cyan C, and black K; and four toner storage units 9Y, 9M, 9C, and 9K that correspond to the respective four colors. The four image forming units 8Y, 8M, 8C, and 8K are arranged with the yellow image forming unit 8Y farthest from the conveyer path 5 and the black image forming unit 8K closest to the conveyer path 5. A toner image is first-transferred from the image forming units 8Y, 8M, 8C, and 8K to an intermediate transfer belt 10.

The intermediate transfer belt 10 is looped across a drive roller 11 disposed adjacent to the conveyer path 5 and an idler roller 12 disposed further outward than the yellow image forming unit 8Y. The toner image carried on the intermediate transfer belt 10 is second-transferred to a sheet of paper P. The sheet of paper P is pressed onto the intermediate transfer belt 10 by a second-transfer roller 13. Thus, in this embodiment, the intermediate transfer belt 10 and the second-transfer roller 13 define a second-transfer unit 14, at a portion of contact between the intermediate transfer belt 10 and the second-transfer roller 13. More specifically, the intermediate transfer belt 10 and the second-transfer roller 13 constitute a contact transfer device.

The image forming units 8Y, 8M, 8C, and 8K each include a photosensitive drum 15, a charging roller 16, and a developer 17. The photosensitive drum 15 is irradiated with laser light from an exposure unit 18 to form the toner image onto the photosensitive drum 15.

The conveyer path 5 includes a pair of guides 19 and 20, and the sheets of paper P accumulated in the feeding cassettes 1 and 2 are sent to the conveyer path 5 on a one-by-one basis by pick-up rollers 21. The conveyer path 5 also includes a pair of timing rollers 23 at a portion that is further downstream than the feeding cassettes 1 and 2 and further upstream than the second-transfer roller 13. The pair of timing rollers 23 ensure accurate synchronization of the forwarding of the sheet of paper P with the toner image on the intermediate transfer belt 10. The conveyer path 5 also includes a sensor, not shown, to sense the sheet of paper P.

As described above, the conveyer path 5 includes the pair of guides 19 and 20. The guide 20 includes a pre-transfer guide 20a disposed between the timing rollers 23 and the second-transfer roller 13. The pre-transfer guide 20a guides the sheet of paper P to the second-transfer roller 13. An environment sensor (e.g., humidity sensor) 37 is disposed adjacent to the pre-transfer guide 20a to sense a transfer environment.

The sheet of paper P past the second-transfer unit 14 is sent to a fixing unit 24. The fixing unit 24 includes a fixing roller 25 heated by a heat source and a pressure roller 26 elastically pressed onto the fixing roller 25. The sheet of paper P past the fixing unit 24 is discharged into the collection tray 4 through between a pair of discharge rollers 27. In duplex printing, a return path may be disposed to return the sheet of paper P from the downstream side of the fixing unit 24 to the upstream side of the timing rollers 23.

### (2) Main Components

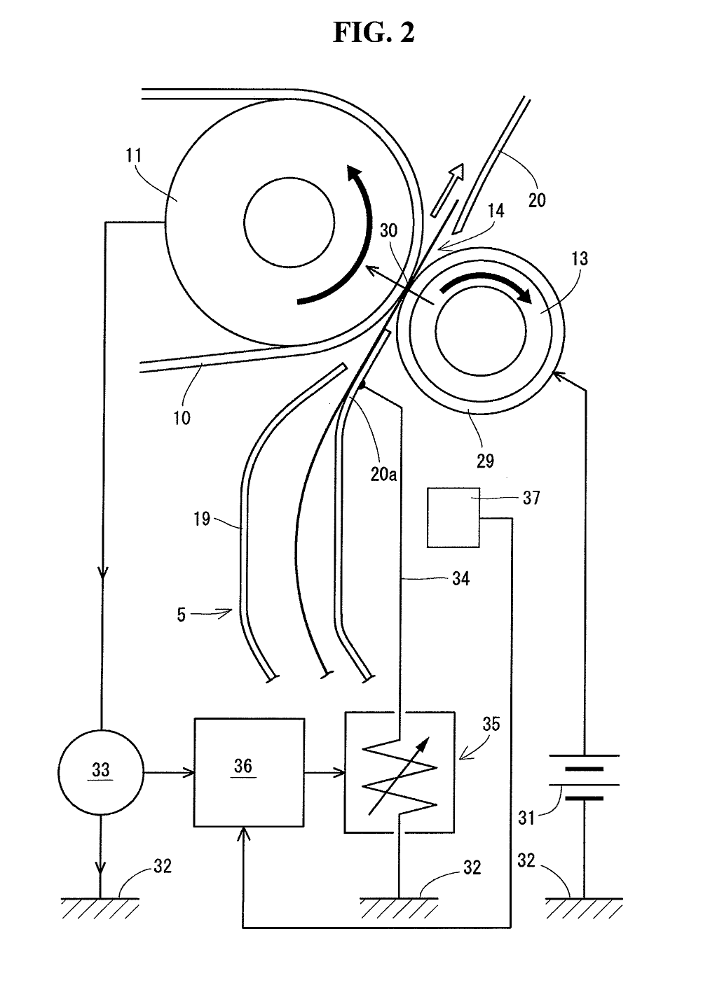

Next, main components of this embodiment will be described by mainly referring to FIG. 2 and later drawings. The second-transfer roller 13 is made of metal (conductor) and includes a conductive soft material 29 over the circumference of the second-transfer roller 13. The soft material 29 is deformed into a nip 30. The second-transfer roller 13 is applied a bias by a power source 31, which is an example of the bias applying device. The second-transfer roller 13 charges the surface of the sheet of paper P to transfer and fix the toner image on the intermediate transfer belt 10 onto the sheet of paper P.

The current applied to the second-transfer roller 13 passes through the sheet of paper P to flow into the intermediate transfer belt 10. In view of this, the drive roller 11, which is made of metal, is utilized as an electrode, and an ammeter 33, which is an example of the transfer current sensor, is interposed between the drive roller 11 and earth (a frame) 32. This ensures accurate and real-time sensing of the value of the current flowing into the second-transfer unit 14.

The current applied by the bias applying device is in large part consumed during the transfer and in small part leaked through the sheet. Still, the bias applying device, the transfer unit, and other components constitute a closed circuit through which the current flows in one direction, satisfying the relationship E=IR, wherein E is voltage, I is current, and R is resistance.

The pre-transfer guide 20a also serves as a leakage current control electrode and is wired to a cable 34 that is coupled to a variable resistor 35, which is an example of the leakage current adjustor. The variable resistor 35 is electronically or mechanically controllable.

The variable resistor 35 allows for both single-step adjustment and multiple-step adjustment. An exemplary multiple-step adjustment is to couple unit resistors in series and choose the number of the unit resistors used by means of a switch circuit, thus switching the resistance in multiple steps. The variable resistor 35 is adjusted (controlled) by a controller 36 based on the value (sensed signal) of the ammeter 33.

The controller 36 can be embodied in various forms. Examples include, but not limited to, a comparator that subtracts a reference upper-limit value and a reference lower-limit value that are stored in advance from a current value transmitted from the ammeter 33. When the subtracted value of the reference upper-limit value is negative and the subtracted value of the reference lower-limit value is positive, the variable resistor 35 may not be adjusted. When the subtracted value of the reference upper-limit value is positive and the subtracted value of the reference lower-limit value is negative, the variable resistor 35 may be driven.

In this embodiment, the current necessary for the transfer at the second-transfer unit 14 is set from 40 μA to 80 μA. That is, the reference range of the current to pass through the second-transfer unit 14 is set from 40 μA to 80 μA. Even though the output applied from the power source 31 is constant, the value of the current passing through the second-transfer unit 14 varies if the value of the current leaked to the pre-transfer guide 20a through the sheet of paper P varies. This means that changing the value of the current leaked through the sheet of paper P changes the value of the current passing through the second-transfer unit 14.

In view of this, in this embodiment, when the current passing through the second-transfer unit 14 is lower than the reference range, the resistance of the variable resistor 35 is increased to reduce the current flowing to the sheet of paper P, thus controlling the current passing through the second-transfer unit 14 within the reference range. When the current passing through the second-transfer unit 14 is higher than the reference range, the resistance of the variable resistor 35 is reduced to increase the leakage current flowing to the sheet of paper P, thus controlling the current passing through the second-transfer unit 14 within the reference range. The bias output does not change in either case, ensuring superior stability.

The appropriate reference range may be subject to change depending on environmental conditions such as humidity. In view of this, an environment sensor 37 may be used to sense values that are related to the appropriate reference range by an experiment or other means. The obtained relationship may be stored in advance in the controller or other locations in the form of a relational equation or a relational table. The reference range may be set by referring the value sensed by the environment sensor 37 to the relational equation or the relational table.

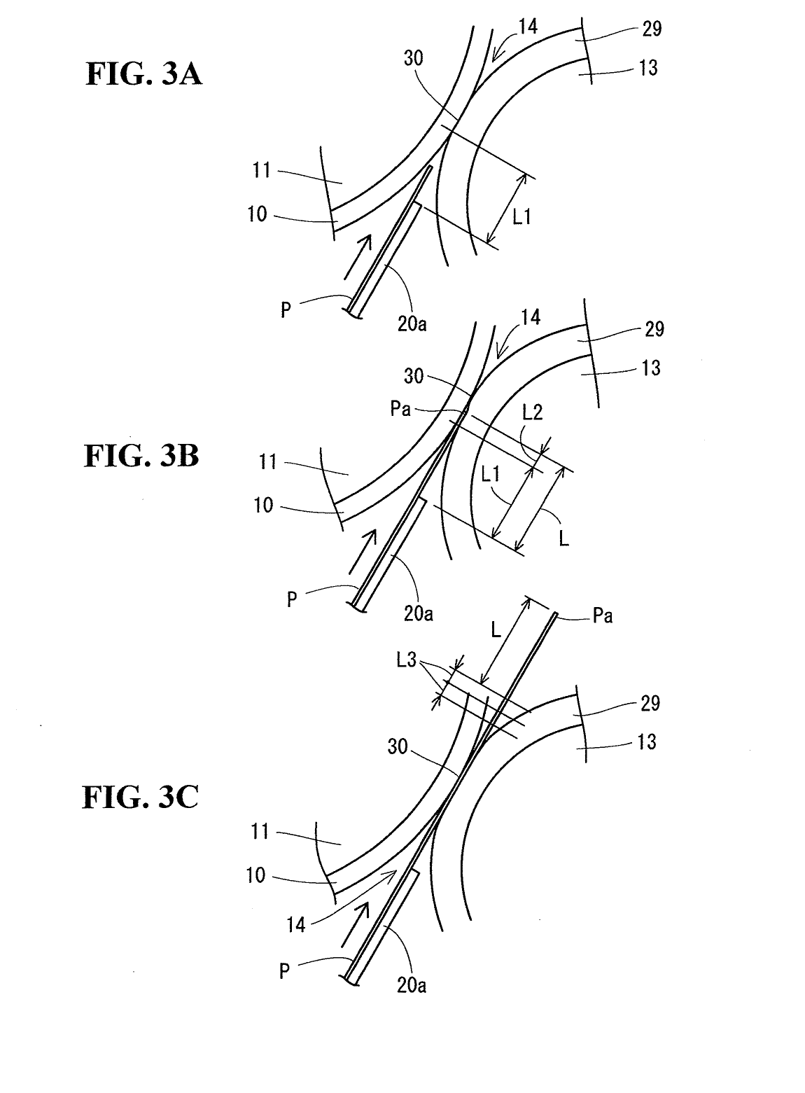

Incidentally, the sheet of paper P may contain moisture entirely or partially. In order to grasp the moist state of the sheet of paper P, the moist state is preferably sensed in a real-time manner while the sheet of paper P is being conveyed. The result of sensing may be fed back to the variable resistor 35, thus realizing real-time control. In this respect, the sensing and variable control according to this embodiment are based on a processing reference unit, which is defined as a space between an edge of the pre-transfer guide 20a and the nip 30. This will be described by referring to FIGS. 3A and 3B.

As shown in FIGS. 3A and 3B, the sheet of paper P leaving the pre-transfer guide 20a migrates into the nip 30, where the sheet of paper P is nipped to start transfer of the toner image. The control starts at a processing start dimension L, which includes a distance L1 from the edge of the pre-transfer guide 20a to the nip 30 and a slight capture margin L2 added to the distance L1. The capture margin L2 may be approximately 1 mm, for example. Alternatively, the capture margin may be defined in terms of time. Specifically, it is possible to set a capture time of 5 milliseconds, for example. The control after the sheet of paper P enters the nip 30 may be based on a predetermined period of time or a predetermined forwarding dimension.

Specifically, as shown in FIG. 3C, the ammeter 33 senses a transfer current as soon as an edge Pa of the sheet of paper P enters the nip 30, and based on the result of sensing, the controller 36 adjusts the resistance of the variable resistor 35 as necessary. After the sheet of paper P enters the nip 30 by the dimension L, the ammeter 33 re-senses the value of the transfer current every time the sheet of paper P forwards by a suitable dimension L3 (or every time a predetermined period of time elapses), and the controller 36 adjusts the resistance of the variable resistor 35 as necessary. L3 may be the same as L2. Alternatively, the control may be based on L instead of L3.

Re-sensing the value of the transfer current on the basis of the constant processing reference dimension L and controlling the leakage current flowing along the sheet of paper P maintain the value of the current passing through the second-transfer unit 14 within a predetermined range. The distance L1 from the pre-transfer guide 20a to the nip 30 is as short as approximately 15 mm, for example, and approximately 16 mm is sufficient for the control reference dimension L. This appropriately accommodates to the situation that the moist state of the sheet of paper P varies portion by portion, thereby ensuring detailed control.

The control elements such as the ammeter 33, the controller 36, and the variable resistor 35 may be disposed adjacent to the second-transfer unit 14 or may be incorporated into a regulatory mechanism that controls the printer.

### (3) Specific Configuration

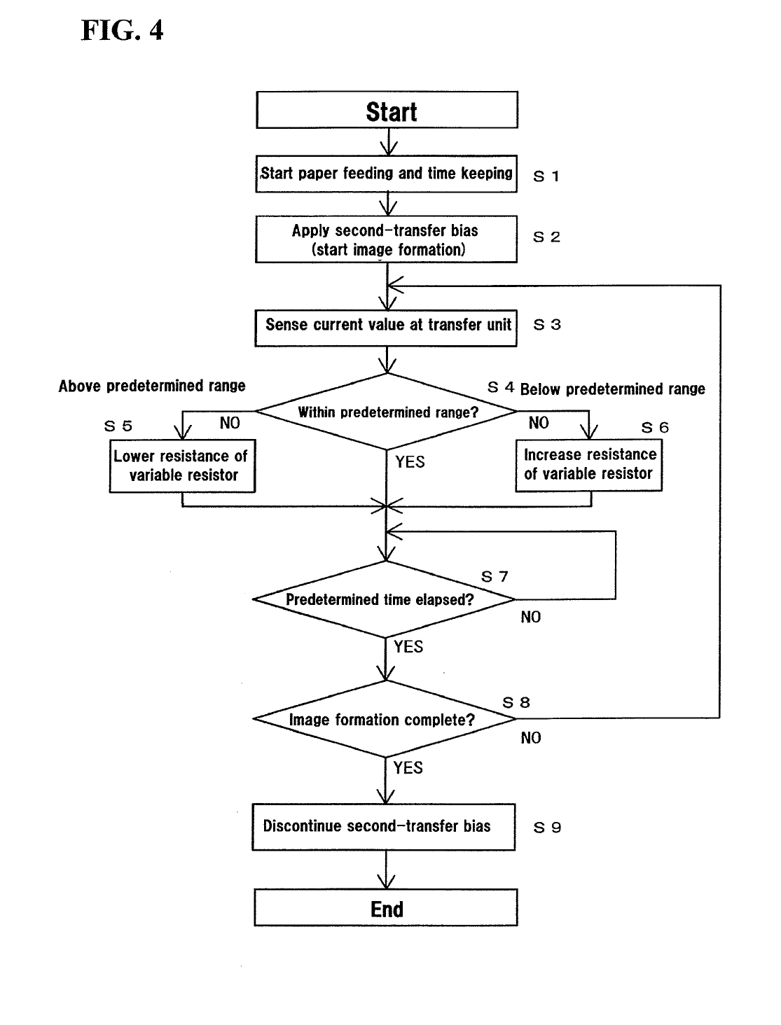

Next, a control embodiment will be described in detail by referring to the flowchart shown in FIG. 4. First, control starts by a printing start signal, which in turn starts forwarding of the intermediate transfer belt 10 and forwarding of a sheet of paper P. Time keeping also starts, simultaneously with the start of forwarding of the sheet of paper P (step 1). The forwarding speed of the sheet of paper P is determined by the rotational speed of the timing rollers 23, and therefore time measurement ensures calculation of the forwarding distance of the sheet of paper P.

Before the sheet of paper P arrives at the second-transfer unit 14, the power source 31 applies a bias to the second-transfer roller 13 (step 2). Next, when a predetermined period of time elapses and an edge of the sheet of paper P enters the nip 30, the ammeter 33 senses the value of the current flowing through the second-transfer unit 14 (step 3).

Next, the controller 36 determines whether the sensed current value is within a predetermined range (step 4). When the sensed current value is within the predetermined range, the controller 36 does not adjust the value of the variable resistor 35. In excess of the predetermined range, the controller 36 reduces the value of the variable resistor 35 in accordance with an extra value to keep the current value of the second-transfer unit 14 within the predetermined range (step 5). When the sensed value is below the predetermined range, the controller 36 increases the value of the variable resistor 35 in accordance with a deficiency value to keep the current value of the second-transfer unit 14 within the predetermined range (step 6).

Upon elapse of a predetermined period of time extending from the first sensing of the current value to the time at which the sheet of paper P is conveyed over a control distance L (step 7=YES), the ammeter 33 senses the current for the second time. Based on the sensed current value, new transfer conditions are determined. This cycle of sensing and determination is routinely repeated. When an image formation is complete (step 8=YES), the bias application to the second-transfer roller 13 is turned OFF (step 9) and the current sensing stops. Thus, the printing of one sheet of paper P is complete. For a continuous print job (step 8=NO), the processing returns to step 3.

The above description is regarding image formation that starts upon entrance of the edge of the sheet of paper P into the nip. It is noted, however, that an actual image may not necessarily be formed over the entire sheet of paper P, but in many cases an image is formed partially on the sheet of paper P. For example, the sheet of paper P may have forward and backward margins or a blank space on the forward or backward side in the forwarding direction of the sheet of paper P.

In view of this, the current sensing may actually start upon elapse of a substantial period of time (or upon travel over a substantial distance) after the sheet of paper P enters the second-transfer unit 14. For the same reason, the current sensing may end even if the sheet of paper P still exists in the second-transfer unit 14. Further, for a discontinuous image on the forward and backward sides in the direction of conveyance of the sheet of paper P, the current sensing may take place only over areas where portions of the image exist. It will be readily appreciated that the processing reference dimension L may be set at any value.

In this embodiment, the ammeter 33 is used as the sensor to sense the value of the current passing through the second-transfer unit 14, and the drive roller 11 is used as a point of contact (electrode) with the cable coupled to the ammeter 33. This ensures a simplified structure. It is of course possible to couple the ammeter 33 to a dedicated electrode (point of contact) that is in contact with the inner surface of the intermediate transfer belt 10.

While in this embodiment the environment sensor 37 is disposed adjacent to the pre-transfer guide 20a, the environment sensor 37 may be secured to the pre-transfer guide 20a or disposed at the guide 19a opposing the pre-transfer guide 20a.

### (4) Miscellaneous

The embodiment of the present invention is not intended to be construed in a limiting sense, but many other embodiments are possible. For example, the present invention also finds applications in what are called direct-transfer image forming apparatuses, which directly transfer a toner image of a photoconductor onto a sheet while it is being passed between the photoconductor and a transfer roller. In this case, the photoconductor and the transfer roller constitute the contact transfer device. The transfer current sensor may sense the current value or sense whether the current value is higher than a preset current value, and may be implemented in a known circuit configuration. The timing roller (resist roller) may also serve as a leakage current control electrode to come into contact with a sheet such as of paper, thereby preventing increase in cost.

The leakage current adjustor may be a variable power source serving as a variable bias applying device, instead of the variable resistor 35. Specifically, the variable power source may change the potential of the pre-transfer guide 20a to adjust the current leaked from the second-transfer unit 14 through the sheet of paper P to the pre-transfer guide 20a. This configuration also provides the above-described advantageous effects.

In the embodiment of the present invention, the leakage current is adjusted to maintain the current consumed in the transfer within a predetermined range. This eliminates the need for changing the output of bias application, ensuring superior bias stability. This also adds to reduction in power consumption (reduction in operation cost). Controlling the leakage current also appropriately accommodates to changes, if any, in environmental factors such as the humidity of sheet, thereby maintaining the transfer current within a predetermined range.

Directly sensing the amount of the current passing through the sheet ensures superior accuracy of sensing and superior real-time performance. In short, the embodiment of the present invention stably and appropriately accommodates to environmental changes to maintain the amount of the transfer current within a predetermined range.

In the embodiment of the present invention, the contact transfer device may include at least one of a transfer belt and a photoconductor configured to carry toner, and a transfer roller configured to press the sheet against the at least one of the transfer belt and the photoconductor. The bias may be applied to the contact transfer device through the transfer roller. That is, the embodiment of the present invention also provides the above-described advantageous effects when applied to what are called indirect transfer systems, in which a transfer belt and a transfer roller constitute the contact transfer device of the image forming apparatus. The embodiment of the present invention also provides the above-described advantageous effects when applied to what are called direct transfer systems, in which a photoconductor and a transfer roller constitute the contact transfer device.

In the embodiment of the present invention, the image forming apparatus may further include a leakage current control electrode electrically coupled to the leakage current adjustor at a portion further upstream than the image transfer position in the direction of conveyance of the sheet. The leakage current control electrode may be configured to come into contact with the sheet. This configuration provides the advantage of high reliability in controlling the leakage current from the sheet.

In the embodiment of the present invention, the leakage current control electrode may include a pre-transfer guide configured to guide the sheet to enter the contact transfer device. This configuration provides the advantage of a simplified structure compared with providing a dedicated member as the leakage current control electrode. Further in this configuration, the leakage current control electrode is disposed adjacent to the transfer unit. This ensures control of higher real-time performance.

In the embodiment of the present invention, the leakage current adjustor may include at least one of a variable resistor and a variable bias applying device. Employing the variable resistor eliminates the need for a power source, ensuring a simplified structure. Employing the variable bias applying device provides the advantage of appropriately accommodating to large changes, if any, in the resistance of the sheet.

In the embodiment of the present invention, the reference range of the transfer current may be from 40 μA to 80 μA. This ensures more stable transfer.

In the embodiment of the present invention, when the value of the transfer current sensed by the transfer current sensor is in excess of the reference range, the leakage current adjustor may be configured to increase the leakage current to the sheet. When the value of the transfer current sensed by the transfer current sensor is lower than the reference range, the leakage current adjustor may be configured to reduce the leakage current to the sheet. This configuration ensures reliable control.

In the embodiment of the present invention, the image forming apparatus may further include an environment sensor configured to sense a transfer environment. The reference range of the transfer current may be changeable based on the transfer environment sensed by the environment sensor. This configuration provides the advantage of appropriately accommodating to changes, if any, in the range of the transfer current necessary for appropriate transfer due to changes in transfer environments (such as humidity). The bias output may also be changed in accordance with a change in the reference range.

The embodiment of the present invention has industrial applicability especially in, but not limited to, image forming apparatuses of printers and multifunctional machines.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. An image forming apparatus comprising:
a contact transfer device configured to transfer a toner image onto a surface of a sheet conveyed in a predetermined direction;
a bias applying device configured to apply a bias to the contact transfer device;
a transfer current sensor configured to sense a value of a transfer current flowing through the sheet at an image transfer position;
a leakage current adjustor configured to adjust an amount of a leakage current flowing from the contact transfer device along the surface of the sheet; and
a controller configured to control the leakage current adjustor to maintain an amount of the transfer current within a reference range based on the value of the transfer current sensed by the transfer current sensor.

2. The image forming apparatus according to claim 1, wherein the contact transfer device comprises
at least one of a transfer belt and a photoconductor configured to carry toner, and
a transfer roller configured to press the sheet against the at least one of the transfer belt and the photoconductor, the bias being applied to the contact transfer device through the transfer roller.

3. The image forming apparatus according to claim 2, further comprising a leakage current control electrode electrically coupled to the leakage current adjustor at a portion further upstream than the image transfer position in the direction of conveyance of the sheet, the leakage current control electrode being configured to come into contact with the sheet.

4. The image forming apparatus according to claim 1, further comprising a leakage current control electrode electrically coupled to the leakage current adjustor at a portion further upstream than the image transfer position in the direction of conveyance of the sheet, the leakage current control electrode being configured to come into contact with the sheet.

5. The image forming apparatus according to claim 4, wherein the leakage current control electrode comprises a pre-transfer guide configured to guide the sheet to enter the contact transfer device.

6. The image forming apparatus according to claim 1, wherein the leakage current adjustor comprises at least one of a variable resistor and a variable bias applying device.

7. The image forming apparatus according to claim 1, wherein the reference range of the transfer current is from 40 μA to 80 μA.

8. The image forming apparatus according to claim 1,
wherein when the value of the transfer current sensed by the transfer current sensor is in excess of the reference range, the leakage current adjustor is configured to increase the leakage current to the sheet, and
wherein when the value of the transfer current sensed by the transfer current sensor is lower than the reference range, the leakage current adjustor is configured to reduce the leakage current to the sheet.

9. The image forming apparatus according to claim 1, further comprising an environment sensor configured to sense a transfer environment,
wherein the reference range of the transfer current is changeable based on the transfer environment sensed by the environment sensor.

10. A method for controlling an image forming apparatus, the image forming apparatus comprising a contact transfer device configured to, when biased, transfer a toner image onto a surface of a sheet conveyed in a predetermined direction, the method comprising:
sensing a value of a transfer current flowing through the sheet at an image transfer position; and
adjusting an amount of a leakage current flowing from the contact transfer device along the surface of the sheet based on the value of the transfer current sensed in the sensing step so as to maintain an amount of the transfer current within a reference range.

11. The method according to claim 10,
wherein when the value of the transfer current sensed in the step of sensing is in excess of the reference range, the leakage current to the sheet is increased in the step of adjusting, and
wherein when the value of the transfer current sensed in the step of sensing is lower than the reference range, the leakage current to the sheet is reduced in the step of adjusting.
